(19) United States
(12) Patent Application Publication
(10) Pub. No.: US 2017/0349171 A1
(43) Pub. Date: Dec. 7, 2017

(54) CONTROLLING A PROTECTION DEVICE OF A MOTOR VEHICLE

(71) Applicant: Robert Bosch GmbH, Stuttgart (DE)

(72) Inventors: Ruediger Jordan, Stuttgart (DE); Steffen Waeldele, Weil Der Stadt (DE); Thomas Maurer, Neuendettelsau (DE)

(21) Appl. No.: 15/593,652

(22) Filed: May 12, 2017

(30) Foreign Application Priority Data
Jun. 2, 2016 (DE) 102016209735.0

(51) Int. Cl. B60W 30/09; B60W 10/18; B60W 10/30

(52) U.S. Cl. CPC B60W 30/09; B60W 10/30; B60W 10/18; B60W 2710/18; B60W 2550/10; B60W 2710/30; B60W 2720/106; B60W 2550/406

(57) ABSTRACT

A method for controlling a motor vehicle including steps of determining a position of the motor vehicle; determining topographical surroundings of the position; and controlling, based on the determined topographical surroundings, a protection device on board the motor vehicle if a collision of the motor vehicle with another object is imminent.

### CROSS REFERENCE

The present application claims the benefit under 35 U.S.C. §119 of German Patent Application No. DE 102016209735.0 filed on Jun. 2, 2016, which is expressly incorporated herein by reference in its entirety.

### Field

The present invention relates to an active protection device for a motor vehicle. In particular, the present invention relates to controlling the protection device.

### Background Information

One or multiple driver assistance systems are provided on board a motor vehicle, which may support a driver in predetermined driving situations. For example, an adaptive cruise control (ACC) may be provided, which maintains the speed of the motor vehicle at a predetermined value and at the same time prevents the motor vehicle from rear-ending a preceding motor vehicle. Such assistance systems may be configured to improve their determination or intervention results based on surroundings information.

German Patent Application No. DE 10 2014 204 383 A1 relates to a driver assistance system which scans surroundings of the motor vehicle and divides these into areas of differing criticality. Areas considered to be critical may be analyzed longer than less critical areas.

German Patent Application No. DE 10 2013 226 004 A1 provides for carrying out an automated emergency braking when a driver-controlled use of brakes is considered to be too sluggish.

It is an object of the present invention to provide an improved technique for controlling a motor vehicle including a protection device. Preferred specific embodiments are described herein.

In accordance with the present invention, a method is provided for controlling a motor vehicle including steps of determining a position of the motor vehicle; determining topographical surroundings of the position based on pieces of map information; and controlling, based on the determined topographical surroundings, an active protection device on board the motor vehicle if a collision of the motor vehicle with another object is imminent. The pieces of topographical information may in particular be provided based on pieces of map information or with the aid of a surroundings sensor system.

The active protection device is configured to assume or influence a longitudinal or transverse control of the motor vehicle. For example, an automatic brake assistance system may be configured to forcibly cause an emergency braking of the motor vehicle. The topographical surroundings of the position may be determined based on map data which are either present locally on board the motor vehicle or may be procured via a mobile data transmission connection. By controlling the active protection device as a function of the determined topographical surroundings, it is possible, on the one hand, to improve a determination as to whether or not the protection device is to intervene, and, on the other hand, the manner in which the protection device takes action may be adapted as a function of the surroundings.

It is preferred that it is determined, based on the determined topographical surroundings, whether or not a collision with the other object is imminent. The other object may in particular be detected with the aid of a sensor on board the motor vehicle. Occasionally, however, measuring or processing errors occur, so that an object is determined where in fact none is present. Conversely, an actually present object may also not be detected by the sensor, for example since the object is partially or entirely shadowed by a structure or vegetation. Taking the topographical surroundings into consideration, the detection and, if necessary, the identification of the object or the determination of its movement may be subjected to a plausibility check. Objects subjected to a plausibility check may have improved relevance for the decision as to whether or not the collision with the other object is impending.

It is furthermore preferred that a trajectory of the motor vehicle or of the other object is predicted based on the determined topographical surroundings. It may be assumed, for example, that the motor vehicle will continue to move on a road or on a path. Various other possible trajectories may thus be discarded. Similarly, it may be predicted that the other object, which in particular may include another motor vehicle or another road user, behaves correspondingly. The type of the other road user (pedestrian, bicyclist and the like) may be used to reduce the number of possible trajectories or those considered to be plausible.

In one further specific embodiment, surroundings of the motor vehicle are scanned with the aid of a sensor, the scanning being interpreted based on the determined topographical surroundings. In particular, poor scans, for example due to unfavorable incident light or vibration, may be improved by the interpretation aid based on the topographical surroundings.

It is furthermore preferred that the function of the protection device on board the motor vehicle is controlled based on the determined topographical surroundings. For example, a restraint system for passengers may operate in different manners, these manners possibly being dependent on the type of hazard for the occupants apparent from the pieces of topographical information.

In one specific embodiment, the protection device is controlled as a function of whether the motor vehicle is situated in the area of an intersection. For example, it may be continuously determined when a collision with the object will take place based on a present situation. This time is also referred to as Time To Collision (TTC) and may be determined assuming various scenarios. When this time drops below a predetermined threshold value, the protection device may be triggered. The threshold value may be made dependent on the type of topological surroundings in which the motor vehicle is situated. For example, the threshold value may be raised in the area of an intersection in order to counteract the particularly frequent accident type of a collision with another motor vehicle in the case of intersecting traffic.

In one further specific embodiment, the protection device is controlled as a function of whether the motor vehicle is situated in the area of a tight curve. In such a driving situation, there is an increased risk that the motor vehicle partially uses the lane for oncoming traffic. Moreover, oncoming traffic may erroneously be interpreted as cross traffic which is on a collision course. Consequently an—unjustified—activation of the safety function may occur. To avoid this, it may be useful in such a situation to react later, and thus less frequently, than at an intersection, for example. For this purpose, in particular the above-mentioned threshold value for the TTC may be lowered.

A control device for a motor vehicle includes a positioning unit for determining a position of the motor vehicle; a data source for pieces of map information for determining topographical surroundings at the position; and a processing unit. The processing unit is configured to control a protection device on board the motor vehicle if a collision of the motor vehicle with another object is imminent.

The control device may contribute to improving a conventional protection device either in its response behavior or in its execution behavior. The control device may in particular be designed as a programmable microcomputer and optionally may be designed having another control device integrated on board the motor vehicle.

In different specific embodiments, the protection device may act in different manners. In a first specific embodiment, the protection device includes an output unit for a warning directed at a driver of the motor vehicle. The warning may be output acoustically, visually or haptically. In a second specific embodiment, the protection device includes an influencing unit for a driver-controlled acceleration request. In particular, the acceleration request of a driver may not be met when it is determined that in this case a collision with another object is imminent. In a third specific embodiment, the protection device includes a braking unit which may automatically activate a braking system on board the motor vehicle in order to decelerate the motor vehicle or maintain it at a standstill. In yet another specific embodiment, the protection device includes an activation unit for a passive protection device, such as an airbag or a seat belt tensioner.

The present invention is described in greater detail below with reference to the figures.

### BRIEF DESCRIPTION OF THE DRAWINGS

FIG. 1 shows a system including a motor vehicle.

FIG. 2 shows a flow chart of a method for controlling the motor vehicle from FIG. 1.

FIG. 3 shows an exemplary driving situation of the motor vehicle from FIG. 1 at an intersection.

### DETAILED DESCRIPTION OF EXAMPLE EMBODIMENTS

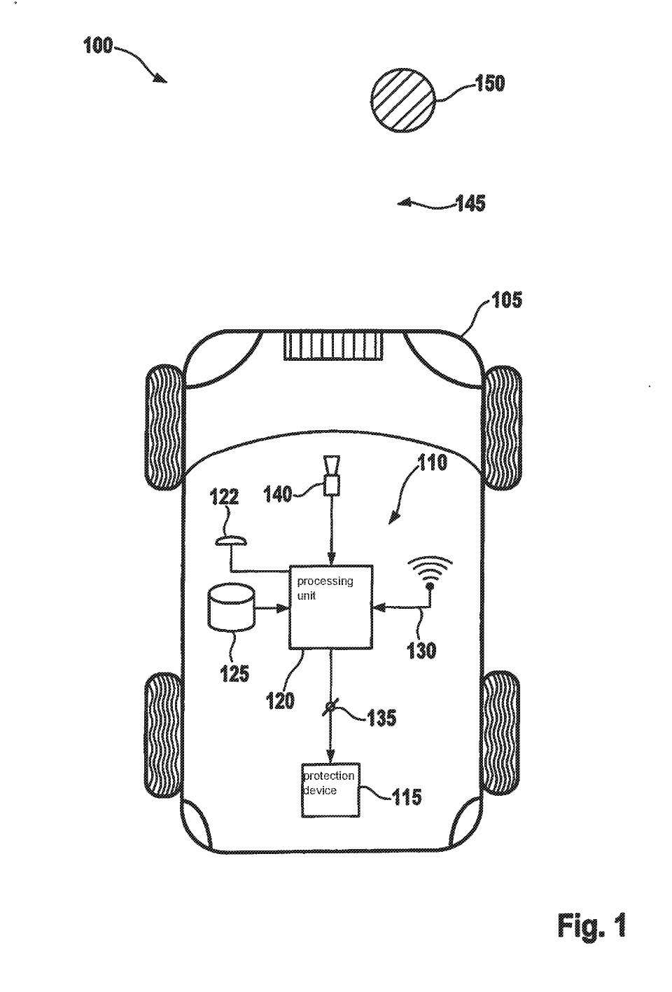

FIG. 1 shows a system 100 including a motor vehicle 105. A control device 110 for controlling a protection device 115 is situated on board motor vehicle 105. Control device 110 includes a processing unit 120 and a data memory 125 or a wireless interface 130. With the aid of an interface 135, processing unit 120 is connected to protection device 115, and preferably to a positioning unit 122. Optionally, additionally a sensor 140 is configured to scan surroundings 145 of motor vehicle 105 and, in particular, to scan an object 150 in surroundings 145. Object 150 may be a stationary or mobile obstacle, with which a collision by motor vehicle 105 is to be avoided.

With the aid of positioning unit 122, a position of motor vehicle 105 may be determined. For this purpose, positioning unit 122 may in particular include a receiver for signals of a satellite-based positioning system. Positioning unit 122 may be part of a navigation system for guiding motor vehicle 105 to a predetermined destination. In one specific embodiment, positioning unit 122 is configured to determine a highly precise position in the range of approximately 1 to 2 cm. In one other specific embodiment, a positioning may be used which is less precise, for example of approximately 1 to 5 m.

Pieces of topographical information about surroundings 145 at the determined position may either be taken from data memory 125 or be received via wireless interface 130. In one specific embodiment, specific pieces of topographical information may be requested via wireless interface 130, for example by a central server, indicating the determined position. Pieces of topographical information may also be provided with the aid of sensor 140, which in particular may include a video camera, by scanning surroundings 145 of motor vehicle 105. Wireless interface 130 may enable a data connection to a data traffic network such as the Internet. Processing unit 120 is configured to control either a triggering of protection device 115 or the execution of the function of protection device 115 based on the determined topographical surroundings 145. In this way, an unwarranted activation of protection device 115 may be avoided or a functional benefit of protection device 115 may be improved.

In one specific embodiment, it is determined, based on the scanning of surroundings 145, with the aid of sensor 140, whether a collision risk with object 150 exists. Since such a measurement is always subject to error, an object 150 may erroneously be determined; this is also referred to as a ghost target. Additionally, it is possible that a traffic situation is misjudged, and a seemingly critical situation in reality is harmless. In general, erroneous activations of protection device 115 may be minimized by triggering protection device 115 as late as possible. A sensory or situational uncertainty may thus be minimized prior to triggering protection device 115.

For example, pieces of topographical information of surroundings 145 may be utilized to detect the progression of a roadway on which motor vehicle 105 or object 150 is situated, or to have an improved overview of an intersection of multiple roads. Correctly and incorrectly assessed objects 150 may thus be distinguished from one another in an improved manner. The criticality of a traffic situation may be assessed more reliably.

Protection device 115 may trigger different measures on motor vehicle 105. One variant is considered hereafter by way of example, which intervenes in an intersection situation during an impending collision with cross traffic. This function is referred to as Front Cross Traffic Assist (FCTA). Within the scope of the FCTA, usually pieces of visual information about approaching cross traffic are scanned with the aid of sensor 140 upon entering a complex intersection. If it is determined that a collision of motor vehicle 105 with object 150 is imminent, a starting or an acceleration of motor vehicle 105 from the creeping mode is prevented. If motor vehicle 105 is already moving at a predetermined speed, for example between 10 km/h and 60 km/h, an automatic partial or full brake application may be initiated when an impending collision with the cross traffic is determined. If a collision is not preventable, a passive safety system on board motor vehicle 105, such as an airbag, may be automatically triggered.

For the decision as to whether protection device 115 (the airbag) is to be triggered, the positions of motor vehicle 105 and/or of object 150 may be predicted. Since the intention of the drivers is usually not known, the prediction may be based on different maneuvers, for example braking, accelerating, turning, defensive or sporty driving style and the like. Out of all variants, the longest Time To Collision is selected. The least critical, i.e., the safest, maneuver is then assigned to this TTC. If the longest TCC drops below a predetermined threshold value, protection device 115 is triggered.

It is provided to control protection device 115 based on pieces of information about topographical surroundings 145 of motor vehicle 105.

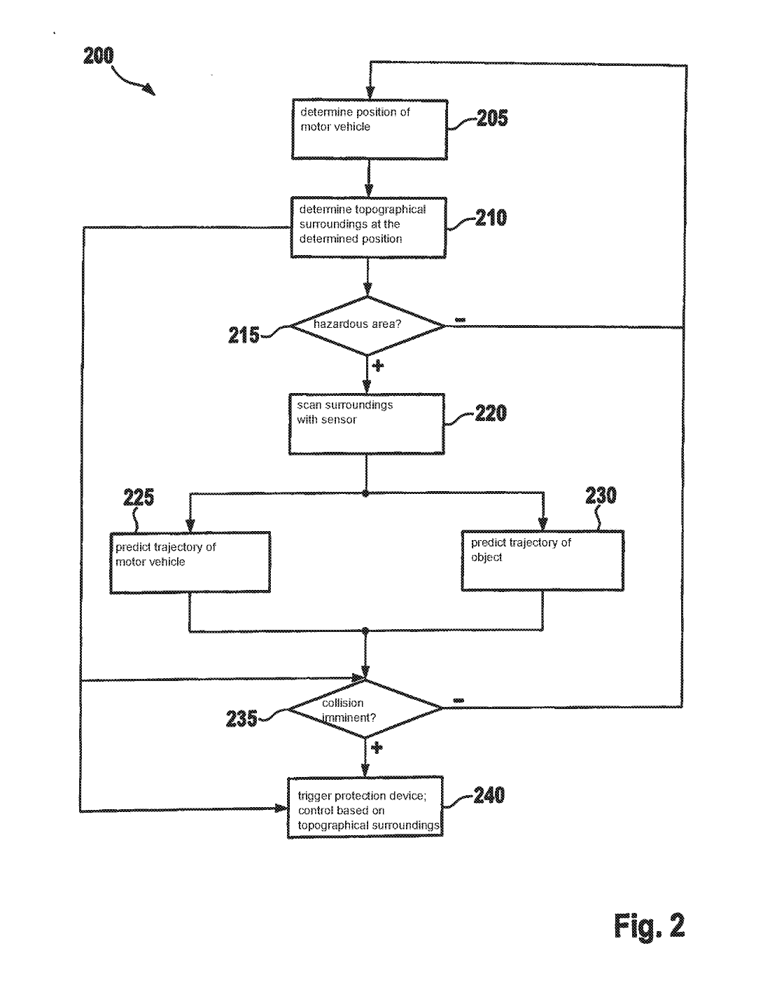

FIG. 2 shows a flow chart of a method 200 for controlling motor vehicle 105 from FIG. 1. Method 200 is in particular configured to run on control device 110, and in particular processing unit 120. For this purpose, processing unit 120 may include a programmable microcomputer, and method 200 may be present in the form of a computer program product at least in parts.

In a step 205, the position of motor vehicle 105 is determined. In a step 210, topographical surroundings 145 at the determined position are determined. In a step 215, it may be determined whether motor vehicle 105 is situated in the area of a topographical territory categorized as hazardous, for example in the area of a curve or an intersection of two or multiple roads. If this is not the case, method 200 may terminate or recommence.

Otherwise, object 150 in surroundings 145 is scanned with the aid of sensor 140 in an optional step 220. If no object 150 is present in surroundings 145, method 200 may also terminate or recommence.

If an object 150 has been found, a trajectory of motor vehicle 105 is preferably predicted concurrently in a step 225, and a trajectory of object 150 is predicted in a step 230. In both steps 225, 230, a plurality of different trajectories may be determined, which in particular may be identified based on the determined topographical surroundings 145.

In a step 235, it is determined whether a collision of motor vehicle 105 with object 150 is imminent. For this determination, the pieces of topographical information of surroundings 145 may be used again. In one specific embodiment, multiple different future scenarios were determined in steps 225 and 230, preferably all of which are analyzed in step 235. Whether or not a collision between motor vehicle 105 and object 150 is imminent in a certain scenario may be determined based on a time which remains until the collision according to the corresponding scenario being below a predetermined threshold value. This remaining time (Time To Collision, TTC) may be determined for all scenarios. If all TTC are above a predetermined threshold value, no collision is imminent, and method 200 may terminate or recommence. It is preferred that the threshold value is varied as a function of topographical surroundings 145 of motor vehicle 105. For example, the threshold value may be the greater, the more complex an intersection is which motor vehicle 105 approaches. By raising the threshold value, the functional benefit of the safety function may be increased.

If it was determined that a collision is imminent, in a step 240 protection device 115 may not only be triggered, but also be controlled based on the determined topographical surroundings 145.

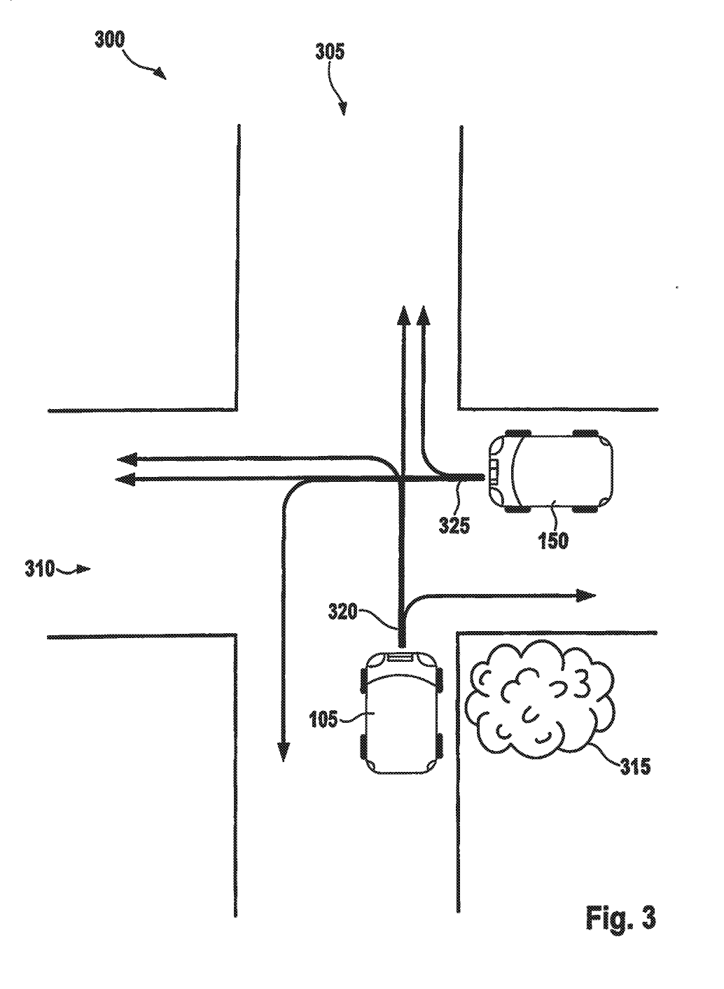

FIG. 3 shows an exemplary driving situation of motor vehicle 105 from FIG. 1 at an intersection 300 of a first road 305 with a second road 310. Motor vehicle 105 approaches intersection 300 on first road 305. Object 150 from FIG. 1 is also a motor vehicle here and approaches intersection 300 on second road 310. A visibility obstruction 315 is situated at one corner of intersection 300, which may impair a correct scanning of motor vehicle 150 on the part of motor vehicle 105. Multiple alternative first trajectories 320 for first motor vehicle 105 and multiple alternative second trajectories 325 for second motor vehicle 150 are plotted by way of example. Usually it is not known for either of motor vehicles 105, 150 which of the possible trajectories 320 or 325 they will pursue. However, different combinations of trajectories 320, 325 may be analyzed as to whether or not a collision between motor vehicles 105, 150 is imminent.

In one specific embodiment, non-drivable maneuvers of one of motor vehicles 105, 150 are excluded in the collision prediction. Such a maneuver may include a departure from roads 305 and 310, for example. The number of the trajectory combinations to be checked may thus be significantly reduced.

Impermissible turning maneuvers of one of motor vehicles 105, 150 may also be excluded from the collision prediction. Other maneuvers which are not permissible according to the road traffic ordinances, such as driving on a one-way road in the wrong direction or turning into the wrong direction, may also be excluded.

The above-described threshold value for the determination of whether or not a collision is imminent may in particular be increased when motor vehicle 105 is situated on a subordinate road 305, i.e., does not have the right of way with respect to motor vehicle 150. The safety function may thus intervene sooner or more progressively.

In one specific embodiment, a driver of motor vehicle 105 is given a visual indication of potentially approaching cross traffic in the form of motor vehicle 150 at an early stage (approximately 5 seconds prior to passing second road 310). A prediction horizon on this order of magnitude of time is considered long, so that it is not possible to exclude a situational uncertainty, and accordingly an unwarranted activation of protection device 115. However, since the warning is only useful in the area of an intersection 300, a piece of information about cross traffic outside intersection 300 would only interfere with or distract the driver of motor vehicle 105. It is thus preferred to output pieces of information about the cross traffic of motor vehicle 150 only to the driver of motor vehicle 105 when it was established, based on the pieces of topographical information, that motor vehicle 105 is situated in the area of an intersection 300.

In a situation other than that illustrated in FIG. 3, motor vehicle 105 is situated in the area of a tight curve, in particular a tight left turn. Due to the curve, an oncoming motor vehicle has a certain speed in the transverse direction with regard to motor vehicle 105, so that it may erroneously be identified as cross traffic. By having knowledge of the topographical information of the curve, an erroneous triggering of protection device 115 may be suppressed in an improved manner. Moreover, protection device 115 may be operated more conservatively, so that it is triggered later than in another situation. In this way, an erroneous triggering may thus be less likely or less frequent.

In yet another specific embodiment, a reaction to an object 150 which is not moving along one of roads 305, 310 may be discarded or postponed to a later point in time.

In one further specific embodiment, a reaction to an object 150 may take place later or not at all if it is not situated on a roadway 305, 310. A so-called “ghost target” may thus be suppressed in an improved manner.

In yet another specific embodiment, a reaction to an object 150 situated behind visibility obstruction 315 may not take place or may take place delayed. In such a situation, it may be assumed that an indication of object 150 represents an erroneous measurement, which was recorded, for example, due to a reflection on a wall or a glass pane by sensor 140. Due to the plausibility check based on topographical map data, an erroneous triggering of protection device 115 may be avoided in an improved manner.

According to the present invention, a driving situation of motor vehicle 105 may be better determined and/or a decision as to whether and how protection device 115 is to be triggered may be made in an improved manner based on a scanning of surroundings 145 of motor vehicle 105, for example with the aid of sensor 140, and topographical data of surroundings 145.

What is claimed is:

1. A method for controlling a motor vehicle, comprising:
determining a position of the motor vehicle;
determining topographical surroundings of the position; and
controlling, based on the determined topographical surroundings, a protection device on board the motor vehicle if a collision of the motor vehicle with another object is imminent.

2. The method as recited in claim 1, further comprising:
determining, based on the determined topographical surroundings, whether or not a collision with the other object is imminent.

3. The method as recited in claim 2, further comprising:
predicting a trajectory of the motor vehicle or of the object is predicted based on the determined topographical surroundings.

4. The method as recited in claim 3, wherein the predicted trajectory is predicted as a function of a path progression in the topographical surroundings.

5. The method as recited in claim 1, further comprising:
scanning surroundings of the motor vehicle with the aid of a sensor, and interpreting the scanning based on the determined topographical surroundings.

6. The method as recited in claim 1, wherein a function of the protection device on board the motor vehicle is controlled based on the determined topographical surroundings.

7. The method as recited in claim 1, wherein the protection device is controlled as a function of whether the motor vehicle is situated in the area of an intersection.

8. The method as recited in claim 1, wherein the protection device is controlled as a function of whether the motor vehicle is situated in the area of a tight curve.

9. A control device for a motor vehicle, the control device comprising:
a positioning unit for determining a position of the motor vehicle;
a data source for pieces of map information for determining topographical surroundings at the position; and
a processing unit configured to control a protection device on board the motor vehicle if a collision of the motor vehicle with another object is imminent.

10. The control device as recited in claim 9, wherein the protection device includes one of an output unit for a warning directed at a driver of the motor vehicle, an influencing unit for a driver-controlled acceleration request, a braking unit, and an activation unit for a passive protection device.
